(19) United States
(12) Patent Application Publication
(10) Pub. No.: US 2025/0305511 A1
(43) Pub. Date: Oct. 2, 2025

(54) BLOWER SYSTEM

(71) Applicant: Hanon Systems, Daejeon (KR)

(72) Inventors: Yu Ho LEE, Daejeon (KR); Jae Chun RYU, Daejeon (KR); Tae Yong PARK, Daejeon (KR)

(73) Assignee: Hanon Systems, Daejeon (KR)

(21) Appl. No.: 19/061,736

(22) Filed: Feb. 24, 2025

(30) Foreign Application Priority Data
Mar. 29, 2024 (KR) 10-2024-0043486

(51) Int. Cl. F04D 29/28; F04D 17/16

(52) U.S. Cl. CPC F04D 29/283; F04D 17/16

(57) ABSTRACT

The present invention relates to a blower unit applied to a vehicle, and by reducing the axial height of the blower hub to remove an unnecessary dead space, it is possible to increase a space in which air may flow, increase an air volume output to the outside in the same power condition, improve the phenomenon in which airflow is biased at a lower portion, reduce noise generated by the blower unit, reduce the weight of the blower unit, and reduce the cost.

### CROSS REFERENCE TO RELATED APPLICATION

The present application claims priority to Korean Patent Application No. 10-2024-0043486, filed Mar. 29, 2024, the entire contents of which is incorporated herein for all purposes by this reference.

### BACKGROUND OF THE INVENTION

### Field of the Invention

The present invention relates to a blower unit applied to a vehicle.

### Description of the Related Art

An air conditioner for a vehicle is installed to cool or heat the interior of a vehicle or remove frost and the like formed on windshields during rain or winter so that a driver can secure front and rear views. The air conditioner may include a blower unit for blowing air into an air conditioner case and an air conditioner unit for cooling or heating the air transferred by the blower unit.

The blower unit may include a scroll case and a blower wheel disposed inside the scroll case. Among them, the blower unit may discharge air into the air conditioner case while rotating inside the scroll case. Since the overall size of the air conditioner tends to decrease due to the recent emerging of electric vehicles, the size of the blower unit is also decreasing.

The blower unit miniaturized in this way has an unsatisfactory air volume and noise reduction compared to conventional blower units. Accordingly, there is an increasing need for research on a blower unit that has a smaller size but implements similar performance compared to the conventional blower units.

### RELATED ART DOCUMENT

### Patent Document

Chinese Patent No. 113043807 “Air inlet housing for heating ventilation air conditioning (HVAC) unit” (2023 Jan. 10.)

### SUMMARY OF THE INVENTION

The present invention has been made in efforts to solve the above problems and is directed to providing a blower system in which, by reducing an axial height of a blower hub to remove an unnecessary dead space, it is possible to increase a space in which air may flow, increase an air volume output to the outside under the same power condition, improve the phenomenon in which airflow is biased at a lower portion, reduce noise generated by the blower unit, reduce the weight of the blower unit, and reduce the cost.

To solve the above problems, a blower unit fixed to a driving shaft of a motor and provided at one side of the motor according to one embodiment of the present invention includes a blower hub including a fixed portion coupled to the driving shaft of the motor and a protection part formed to extend radially with respect to the fixed portion and protect one side of the motor, a ring member provided at one side of the blower hub and formed in a ring shape, and a plurality of blades each having one side connected to the ring member along a circumference of the ring member and the other side connected to the blower hub, wherein the protection part includes a bent portion of which inclination changes in a direction toward the motor from an outside to an inside of the motor in the radial direction.

In addition, the bent portion is formed in a circumferential direction with respect to a center line of the driving shaft of the motor.

In addition, an outer housing provided outside the motor to protect the motor has an open side facing the blower hub to form an opening, and the bent portion is formed radially outward more than the opening of the outer housing.

In addition, the outer housing includes a body protrusion formed to protrude to a predetermined height in an axial direction of the motor along an outer edge of the opening, and the bent portion is formed between the opening of the outer housing of the motor and the body protrusion.

In addition, an axial height of the protection part is 10 mm or more and less than 20 mm.

In addition, the protection part includes a flat portion formed to extend radially from the fixed portion and cover and protect one surface of the motor, and an inclined portion formed to extend radially outward from the flat portion and cover and protect a side surface of the motor, and the bent portion is a curved portion between the flat portion and the inclined portion.

In addition, the flat portion and the inclined portion are formed to have a curved surface having a predetermined radius of curvature, and the radius of curvature of the flat portion is greater than the radius of curvature of the inclined portion.

In addition, the flat portion has one end coming into contact with the inclined portion and the other end coming into contact with the fixed portion, and inclination between the one end and the other end of the flat portion is 45 degrees or less.

In addition, the flat portion is formed to have a flat surface, and the inclined portion is formed to have a curved surface having a predetermined radius of curvature.

In addition, the protection part further includes a connecting portion, which connects the flat portion with the inclined portion, between the flat portion and the inclined portion, the connecting portion is formed to have a curved surface having a predetermined radius of curvature, and the radius of curvature of the connecting portion is smaller than the radius of curvature of the flat portion and equal to or smaller than the radius of curvature of the inclined portion.

In addition, the flat portion is formed to be curved convexly outward of the motor, and the inclined portion is formed to be curved convexly inward of the motor.

In addition, the protection part is formed to correspond to shapes of one surface and the other surface of the motor, and formed in a shape spaced a predetermined distance from the one surface and side surface of the motor.

In addition, a spacing distance between the protection part and the one surface and side surface of the motor is 4 mm or more and less than 6 mm.

In addition, the blade is formed in a shape that gradually lengthens radially in a direction from a first surface coming into contact with the ring member toward a second surface coming into contact with the blower hub.

In addition, the blade is formed so that a first angle formed by a first virtual line passing through a center point of the ring member and a second virtual line connecting the center point of the ring member with a center of a first end portion at a second surface side coming into contact with the blower hub is greater than a second angle formed by the first virtual line and a third virtual line connecting the center point of the ring member with a center of the first end portion at the first surface side coming into contact with the ring member.

### BRIEF DESCRIPTION OF THE DRAWINGS

FIG. 1 is a perspective view illustrating a blower system of the present invention.

FIG. 2 is a cross-sectional view of the blower system of the present invention.

FIG. 3 is a graph illustrating airflow when the blower system of the present invention is applied.

FIG. 4 is a graph comparing the noise levels of the baseline model and hub reduced model which the present invention is applied.

FIGS. 5 and 6 are cross-sectional views illustrating a specific shape of the blower system of the present invention.

FIG. 7 is a cross-sectional view illustrating a blower system according to one embodiment of the present invention of a blower hub of the present invention.

FIG. 8 is a schematic view illustrating a first embodiment of a blade of the blower system of the present invention.

FIG. 9 is a schematic view illustrating a second embodiment of the blade of the blower system of the present invention.

### DETAILED DESCRIPTION OF THE INVENTION

Hereinafter, the technical spirit of the present invention will be described in more detail with reference to the accompanying drawings. Prior to this, terms or words used in this specification and claims should not be interpreted as limited to their usual or dictionary meanings and should be interpreted as meanings and concepts that conform to the technical idea of the present invention based on the principle that the inventor can appropriately define the concepts of the terms in order to describe his or her own invention in the best way.

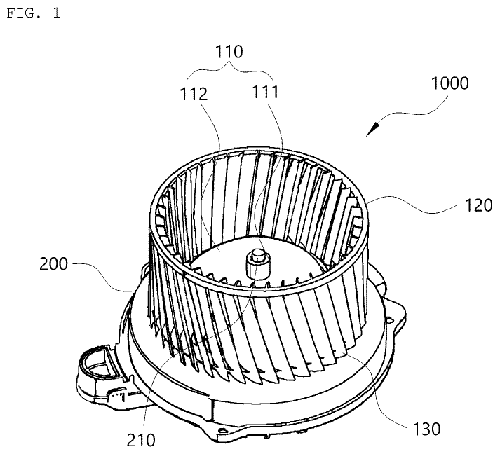

Hereinafter, the overall configuration and effects of a blower system 1000 of the present invention will be described with reference to FIGS. 1 to 4.

As illustrated in FIG. 1, the blower system 1000 of the present invention may include a blower unit 100 and a motor 200. More specifically, the blower unit 100 may be fixed to a driving shaft 210 of the motor 200, provided at one side of the motor 200, and may serve to guide air into an air conditioning case (not illustrated) in a heating, ventilation, and air conditioning (HAVC) system of a vehicle. The blower unit 100 may include a blower hub 110, a ring member 120, and a blade 130. The blower hub 110 may include a fixing part 111 coupled to the driving shaft 210 of the motor 200, and a protection part 112 formed to extend radially centered on the fixing member 111 and protect one side of the motor 200. In addition, the ring member 120 may be provided at one side of the blower hub 110 and formed in a ring shape. The ring member 120 may have a shape with an empty interior and may be provided in a shape having a circular outer circumferential surface and inner circumferential surface. The arrangement locations of a plurality of blades 130 may be set depending on a location of the ring member 120. In addition, the blade 130 may be provided as a plurality of blades in a circumferential direction of the motor 200 and may have one side connected to the ring member 120 in the circumferential direction of the ring member 120 and the other side connected to the hub.

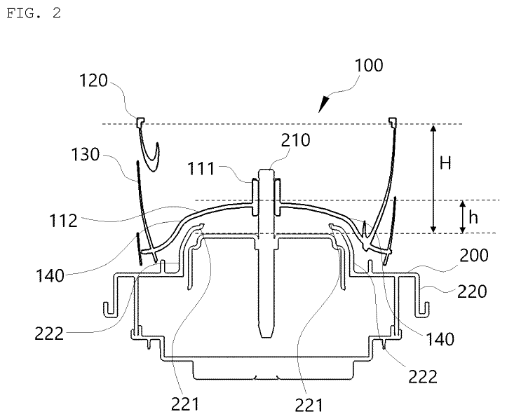

In this case, as illustrated in FIG. 2, the protection part 112 may include at least one bent portion 140 of which inclination changes in a direction toward the motor 200 from the outside to the inside of the motor 200 in the radial direction. In addition, the bent portion 140 may be formed in the circumferential direction with respect to a center line of the driving shaft 210 of the motor 200. That is, the bent portion 140 may be formed in a point-symmetrical shape with respect to the driving shaft 210 of the motor 200.

The motor 200 may include an outer housing 220 provided outside the motor 200 to protect the motor, and the outer housing 220 may have an open side facing the blower hub 110 to form an opening 221. In addition, the outer housing 220 may include a body protrusion 222 formed to protrude to a predetermined height in an axial direction of the motor 200 along an outer edge of the opening 221. In this case, the bent portion 140 may be formed radially outward more than the opening 221 of the outer housing 220 of the motor 200, and the bent portion 140 may be formed between the opening 221 of the outer housing 220 of the motor 200 and the body protrusion 222. Accordingly, since the protection part 112 may be formed in a shape corresponding to the outer housing 220 of the motor 200, an axial height of the blower hub 112 can be reduced.

In addition, an axial height h of the protection part 112 may be formed to be lower than an axial height H of the blade 130. For example, the axial height h of the protection part 112 may be 10 mm or more and less than 20 mm, and the total height H of the blade 130 having one end coupled to the ring member 120 and the other end coupled to the blower hub 110 may be formed to be higher than the axial height h of the protection part 112.

To this end, the motor 200 of the present invention may have a shape in which one end of the driving shaft 210 protruding from one surface is located inward more than the ring member 120 in the axial direction. For example, the motor 200 may be a brushless DC (BLDC) motor 200. In this way, by reducing the axial height of the motor 200 and reducing the axial height of the protection part 112 accordingly, it is possible to increase a space in which air may flow, increase an air volume output to the outside under the same power condition, improve the phenomenon in which airflow is biased at a lower portion, reduce noise generated by the blower unit 100, reduce the weight of the blower unit 100, and reduce the cost.

TABLE 1

| | Result of analyzing CFD | | |
|---|---|---|---|
| | Air volume | Constant pressure | Efficiency |
| | CMH | mmAq | % |
| Conventional one | 527.5 | 29.4 | 26.3 |
| Present invention | 545.8 | 31.3 | 27.7 |

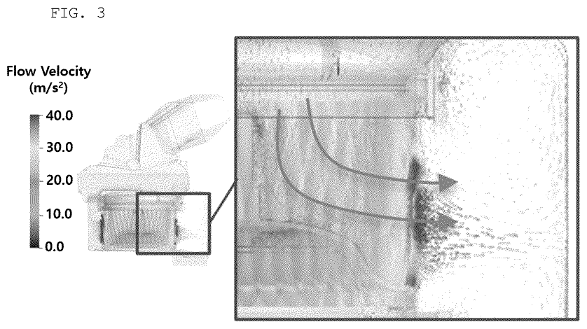

Describing the effects of the present invention in more detail, by applying the shape of the blower system 1000 of the present invention, as shown in Table 1 and FIG. 3, since the space in which air could flow inside the blower unit 100 was increased, it was confirmed that the air volume per hour was increased by about 3.5% compared to the conventional blower unit.

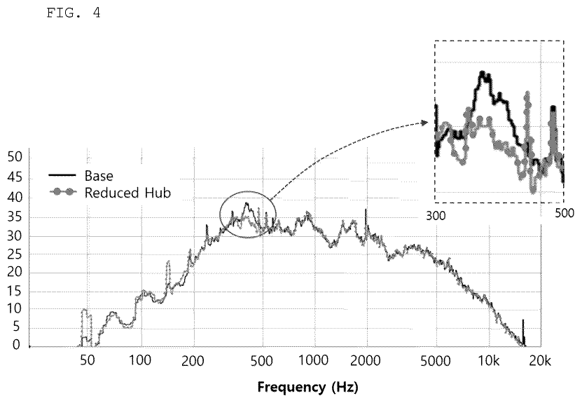

In addition, as in the graph illustrated in FIG. 4, since the space in which air may flow inside the blower unit 100 is increased compared to the conventional blower unit and the hub is formed lower than that of the conventional blower unit, it can be confirmed that it is possible to reduce the generation of noise by allowing air particles to less collide with the hub compared to the conventional blower unit. In particular, the noise reduction effect is clearly exhibited within the range of 300 to 500 Hz.

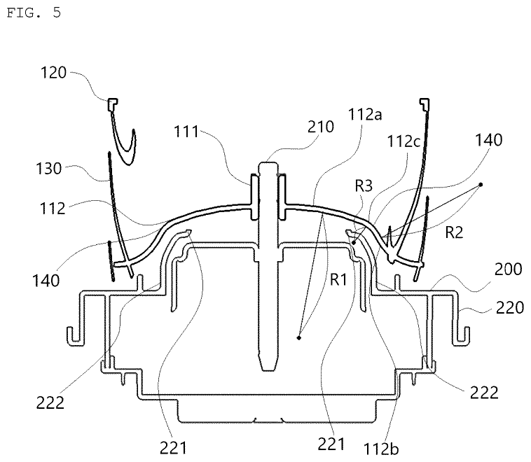

Hereinafter, an embodiment of the shape of the blower hub 110 of the present invention will be described in more detail with reference to FIGS. 5 to 7.

As illustrated in FIG. 5, the protection part 112 may include a flat portion 112a that extends radially outward from the fixed portion 111 and covers and protects one surface of the motor 200, and an inclined portion 112b that extends radially outward from the flat portion 112a and covers and protects a side surface of the motor 200. In this case, the bent portion 140 may be a bent portion between the flat portion 112a and the inclined portion 112b. The flat portion 112a and the inclined portion 112b may be formed in a curved surface having a predetermined radius of curvature. In addition, the protection part 112 may further include a connecting portion 112c, which connects the flat portion 112a with the inclined portion 112b, between the flat portion 112a and the inclined portion 112b. The connecting portion 112c may also be formed in a curved surface having a predetermined radius of curvature, such as the flat portion 112a and the inclined portion 112b. In this way, the flat portion 112a, the inclined portion 112b, and the connecting portion 112c may all be formed in a curved surface, thereby minimizing corners and smoothing the flow of air flowing along the outer side of the blower hub 110.

In addition, the flat portion 112a may be formed to be convexly curved outward of the motor 200, the inclined portion 112b may be formed to be convexly curved inward of the motor 200, and a radius of curvature R1 of the flat portion 112a may be formed to be larger than a radius of curvature R2 of the inclined portion 112b. That is, by forming the flat portion 112a side more gently than the inclined portion 112b side, it is possible to reduce the axial height h of the protection part 112 and increase the space between the outer side of the blower hub 110 and the blade 130, thereby increasing the space in which air may flow.

In addition, an average inclination of the flat portion 112a may be 45 degrees or less. More specifically, the flat portion 112a may have one end coming into contact with the inclined portion 112b, and the other end coming into contact with the fixed portion 111 into which a shaft of the motor 200 is inserted, and inclination between the one end and the other end of the flat portion 112a may be 45 degrees or less. Accordingly, the air flowing into the blower wheel can be prevented from being guided along a steep inclination and can also be prevented from being biased toward a lower end portion of the blower wheel and discharged.

In addition, a radius of curvature R3 of the connecting portion 112c may be formed to be smaller than the radius of curvature R1 of the flat portion 112a and equal to or smaller than the radius of curvature R2 of the inclined portion 112b. Accordingly, an inflection point may be formed between the flat portion 112a and the connecting portion 112c and between the connecting portion 112c and the inclined portion 112b, and a minimum gap may be maintained between the blower hub 110 and one side of the motor 200, thereby minimizing collision between the motor 200 and the blower hub 110.

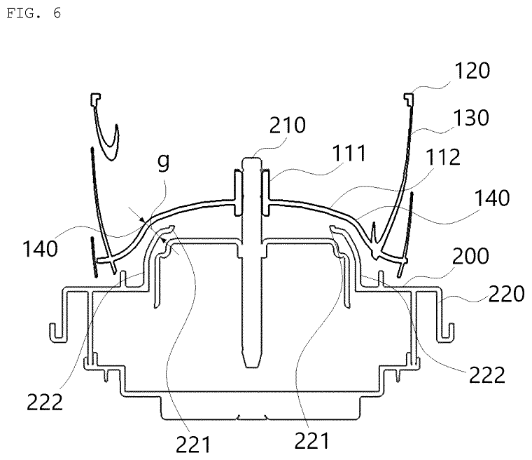

In addition, as illustrated in FIG. 6, the protection part 112 may be formed to correspond to the shapes of the one surface and side surface of the motor 200, and in this case, may be formed in a shape spaced a predetermined distance from the one surface and side surface of the motor 200. More specifically, a spacing distance g between the protection part 112 and the one surface and side surface of the motor 200 may be 4 mm or more and less than 6 mm. Accordingly, the height h of the protection part 112 can be reduced as much as possible, and at the same time, when the blower system 1000 of the present invention is driven, even when vibration occurs in the blower unit 100 and the motor 200, the blower hub 110 and the motor 200 may not come into contact or collide with each other.

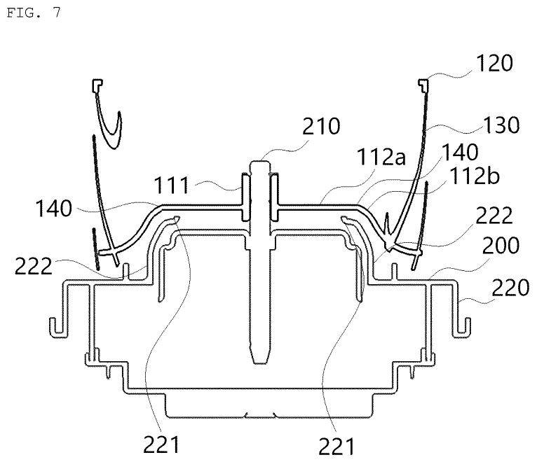

In addition, in one embodiment of the blower hub 110 of the present invention illustrated in FIG. 7, the flat portion 112a may be formed to have a flat surface, and the inclined portion 112b may be formed to have a curved surface having a predetermined radius of curvature. Accordingly, it is possible to reduce the axial height h of the protection part 112 as much as possible and further increase the space in which air may flow compared to other embodiments.

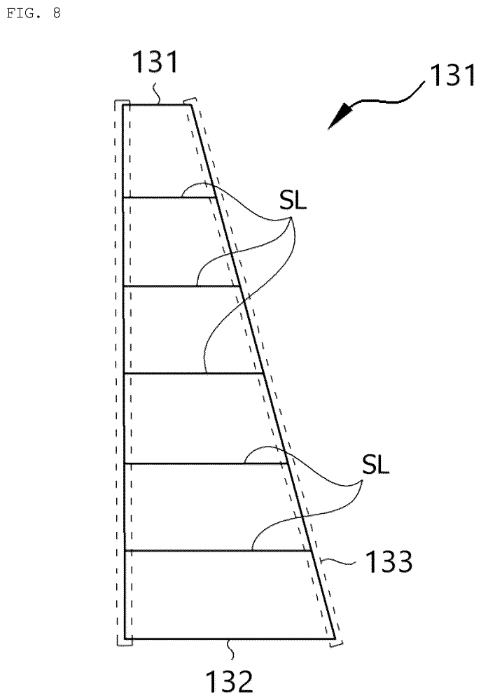

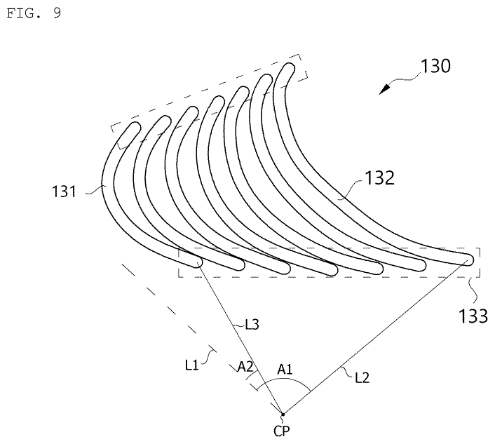

Hereinafter, an additional embodiment and a difference in effects through combination with the additional embodiment will be described with reference to FIGS. 8 and 9.

Except for the reduced shape of the blower hub 110, the blower system 1000 of the present invention may include a number of structures that increase airflow efficiency under the same power condition and reduce noise. In a first embodiment illustrated in FIG. 8, the blade 130 may be formed in a shape that gradually lengthens radially in a direction from a first surface 131 coming into contact with the ring member 120 toward a second surface 132 coming into contact with the hub. In addition, in a second embodiment illustrated in FIG. 9, the blade 130 may be formed so that a first angle A1 formed by a first virtual line L1 passing through a center point of the ring member 120 and a second virtual line L2 connecting the center of a first end portion 133 at the second surface 132 side with the center point of the ring member 120 is greater than a second angle A2 formed by the first virtual line L1 and a third virtual line L3 connecting the center of the first end portion 133 at the first surface 131 side with the center point CP of the ring member 120. That is, the blade 130 may be formed in a twisted shape so as to be oblique to the axial direction of the motor 200. In addition, the blade 130 may include a curved surface formed convexly at one side in the circumferential direction and may be formed in a shape that has a thickness decreasing toward an edge of the curved surface. For example, the thickness of the center may be about 0.45 mm, and the thickness of the edge may be about 0.3 mm.

TABLE 2

| | Air volume at outlet | | Noise evaluation | | P-Q evaluation | |
|---|---|---|---|---|---|---|
| | Air volume | Current | Noise | Current | Constant pressure | Efficiency |
| | [CMH] | [A] | [dB] | [A] | [mmAq] | [%] |
| Conventional one | 502 | 18.5 | 57.8 | 19.1 | 36.8 | 26.4 |
| Present invention | 542 | 20.7 | 57.9 | 16.3 | 45.1 | 30.8 |

As shown in Table 2, when the above-described additional embodiment was applied to the present invention, it was confirmed that the air volume of the present invention increased by about 8% under the same motor 200 power condition compared to the conventional design, and it was confirmed that noise was substantially the same, and it was confirmed that, under the same motor 200 power and same air volume conditions, P-Q increased by about 23% and efficiency also increased by about 4.4%.

According to the blower system of the present invention in accordance with the above configuration, by reducing the axial height of the blower hub to remove an unnecessary dead space, it is possible to increase a space in which air may flow, increase an air volume output to the outside under the same power condition, improve the phenomenon in which airflow is biased at a lower portion, reduce noise generated by the blower unit, reduce the weight of the blower unit, and reduce the cost.

The technical spirit of the present invention should not be construed as limited to the above-described embodiments. Not only the scope of applications is diverse, but also various modifications may be made by those skilled in the art without departing from the gist of the present invention as claimed in the claims. Therefore, these improvements and changes fall within the scope of the present invention as long as they are obvious to those skilled in the art.

### DESCRIPTION OF REFERENCE NUMERALS

1000: blower system
100: blower unit
110: blower hub
111: fixing part
112: protection part
112a: flat portion
112b: inclined portion
112c: connecting portion
120: ring member
130: blade
131: first surface
132: second surface
133: first end portion
140: bent portion
200: motor
210: driving shaft
220: outer housing
221: opening
222: body protrusion
h: axial height of protection part
H: entire axial height of blade
R1: radius of curvature of flat portion
R2: radius of curvature of inclined portion
R3: radius of curvature of connecting portion
g: distance between protection part and motor
SL: cross-sectional line of blade
L1: first virtual line
L2: second virtual line
L3: third virtual line
CP: center line of ring member
A1: first angle
A2: second angle

What is claimed is:

1. A blower unit fixed to a driving shaft of a motor and provided at one side of the motor, the blower unit comprising:
a blower hub including a fixed portion coupled to the driving shaft of the motor and a protection part formed to extend radially with respect to the fixed portion and protect one side of the motor;
a ring member provided at one side of the blower hub and formed in a ring shape; and
a plurality of blades each having one side connected to the ring member along a circumference of the ring member and the other side connected to the blower hub,
wherein the protection part includes a bent portion of which inclination changes in a direction toward the motor from an outside to an inside of the motor in the radial direction.

2. The blower unit of claim 1, wherein the bent portion is formed in a circumferential direction with respect to a center line of the driving shaft of the motor.

3. The blower unit of claim 1, wherein an outer housing provided outside the motor to protect the motor has an open side facing the blower hub to form an opening, and
the bent portion is formed radially outward more than the opening of the outer housing.

4. The blower unit of claim 3, wherein the outer housing includes a body protrusion formed to protrude to a predetermined height in an axial direction of the motor along an outer edge of the opening, and
the bent portion is formed between the opening of the outer housing of the motor and the body protrusion.

5. The blower unit of claim 1, wherein an axial height of the protection part is 10 mm or more and less than 20 mm.

6. The blower unit of claim 1, wherein the protection part includes:
a flat portion formed to extend radially from the fixed portion and cover and protect one surface of the motor; and
an inclined portion formed to extend radially outward from the flat portion and cover and protect a side surface of the motor, and
the bent portion is a curved portion between the flat portion and the inclined portion.

7. The blower unit of claim 6, wherein the flat portion and the inclined portion are formed to have a curved surface having a predetermined radius of curvature, and
the radius of curvature of the flat portion is greater than the radius of curvature of the inclined portion.

8. The blower unit of claim 6, wherein the flat portion has one end coming into contact with the inclined portion and the other end coming into contact with the fixed portion, and
inclination between the one end and the other end of the flat portion is 45 degrees or less.

9. The blower unit of claim 6, wherein the flat portion is formed to have a flat surface, and
the inclined portion is formed to have a curved surface having a predetermined radius of curvature.

10. The blower unit of claim 7, wherein the protection part further includes a connecting portion, which connects the flat portion with the inclined portion, between the flat portion and the inclined portion,
the connecting portion is formed to have a curved surface having a predetermined radius of curvature, and
the radius of curvature of the connecting portion is smaller than the radius of curvature of the flat portion and equal to or smaller than the radius of curvature of the inclined portion.

11. The blower unit of claim 7, wherein the flat portion is formed to be curved convexly outward of the motor, and
the inclined portion is formed to be curved convexly inward of the motor.

12. The blower unit of claim 1, wherein the protection part is formed to correspond to shapes of one surface and the other surface of the motor, and
formed in a shape spaced a predetermined distance from the one surface and side surface of the motor.

13. The blower unit of claim 12, wherein a spacing distance between the protection part and the one surface and side surface of the motor is 4 mm or more and less than 6 mm.

14. The blower unit of claim 1, wherein the blade is formed in a shape that gradually lengthens radially in a direction from a first surface coming into contact with the ring member toward a second surface coming into contact with the blower hub.

15. The blower unit of claim 1, wherein the blade is formed so that a first angle formed by a first virtual line passing through a center point of the ring member and a second virtual line connecting the center point of the ring member with a center of a first end portion at a second surface side coming into contact with the blower hub is greater than a second angle formed by the first virtual line and a third virtual line connecting the center point of the ring member with a center of the first end portion at the first surface side coming into contact with the ring member.
